(19) United States
(12) Patent Application Publication
(10) Pub. No.: US 2006/0083929 A1
(43) Pub. Date: Apr. 20, 2006

(54) Method for producing polyurethane synthetic leather using non-solvent and synthetic leather produced by the method

(76) Inventor: Jong-Hoi Lee, Sasang-Gu (KR)

Correspondence Address: ST. ONGE STEWARD JOHNSTON & REENS, LLC, 986 BEDFORD STREET, STAMFORD, CT, 06905-5619, US

(21) Appl. No.: 10/967,532

(22) Filed: Oct. 18, 2004

(51) Int. Cl. B32B 27/40; B05D 3/02; B05D 1/18

(52) U.S. Cl. 428/423.1; 428/904; 427/430.1; 427/372.2

(57) ABSTRACT

Disclosed is a method for producing non-solvent polyurethane synthetic leather, without using a solvent lethal to a human body. The method includes mixing isocyanate and polyol in a mixing chamber to produce non-solvent polyurethane in a gel state, applying the non-solvent polyurethane onto a release sheet, adhering a fabric to the non-solvent polyurethane, and aging the non-solvent polyurethane.

### BACKGROUND OF THE INVENTION

1. Field of the Invention

The present invention relates to a method for producing polyurethane synthetic leather, and more particularly, to a method for producing non-solvent polyurethane synthetic leather, without using a solvent lethal to a human body.

2. Background of the Related Art

Production of polyurethane synthetic leather is mainly implemented through a dry method or a wet method, both methods of which must use a solvent detrimental to environment and humans.

Specifically, the wet method provides a fabric with water vapor permeability by mixing polyurethane and dimethylformamide as an organic solvent to prepare a resin composite, coating a fabric with the resin composite in a desired thickness, immersing the coated fabric into water to infiltrate droplets into the resin composite, and drying the fabric by using a dryer.

The dry method produces a uniform polyurethane film on a fabric by dissolving polyurethane into a high-volatile organic solvent (e.g., methylethylketone, toluene, acetone, isopropyl alcohol, etc.) to prepare a resin composite, coating a fabric with the resin composite in a desired thickness, and heat-treating the fabric to volatilize the solvent. The above dry method provides leather with no water vapor permeability. Also, the dry method uses the organic solvent, which is a pollution process detrimental to the human body.

Meanwhile, there is another dry method for producing a leather with water vapor permeability, which includes dissolving polyurethane into a high-volatile organic solvent (e.g., methylethylketone, toluene, acetone, isopropyl alcohol, etc.) to prepare a resin composite, depositing the resin composite on a smooth surface of a release sheet in a desired thickness, and heat-treating the fabric to volatilize the solvent, thereby producing a polyurethane film having the water vapor permeability. The polyurethane film is uniformly coated with an adhesive resin, which is formed by mixing polyurethane adhesive component with an organic solvent, by using a proper means, such as knife, and is then attached with a fabric to obtain leather having the water vapor permeability.

Since the above methods utilize the high-volatile organic solvent, such as methylethylketone, toluene, acetone, isopropyl alcohol, etc., volatile organic chemical material is released in the atmosphere; there are some problems of explosion, air pollution and noxiousness.

In particular, the organic solvents used when producing the polyurethane synthetic leather are detrimental to the human body. If these materials are sucked in or contacted with a skin, it can cause vomiting and cutaneous disorder. When a human is exposed to the materials for a long time, the human body is undergone fatal influence. Of course, the material is a cause of atmosphere pollution.

The conventional polyurethane synthetic leather containing the organic solvent has an active migration of pigment. Also, a color of a product is changed by ultraviolet rays, and color development and tactile impression are remarkably decreased.

### SUMMARY OF THE INVENTION

Accordingly, the present invention is directed to a method for producing polyurethane synthetic leather that substantially obviates one or more problems due to limitations and disadvantages of the related art.

An object of the present invention is to provide a method for producing non-solvent polyurethane synthetic leather, without using a solvent lethal to a human body.

Another object of the present invention is to provide a method for producing polyurethane synthetic leather using a non-solvent lethal, which does not require additional drying and adhering processes.

Still another object of the present invention is to provide eco-polyurethane synthetic leather harmless to a human body.

To achieve the object and other advantages, according to one aspect of the present invention, there is provide a method of producing a synthetic leather using isocyanate and polyol, the method comprising the steps of: mixing the isocyanate and the polyol in a mixing chamber to produce non-solvent polyurethane in a gel state; applying the non-solvent polyurethane onto a release sheet; adhering a fabric to the non-solvent polyurethane; and aging the non-solvent polyurethane.

The method further comprises, after the non-solvent polyurethane is applied to the release sheet, drying the non-solvent polyurethane at a temperature of 30 to 100° C. during 10 to 20 seconds.

Preferably, the aging step is implemented at a temperature of 40° C. during 24 hours, and the fabric is impregnated with water-soluble polyurethane.

It is to be understood that both the foregoing general description and the following detailed description of the present invention are exemplary and explanatory and are intended to provide further explanation of the invention as claimed.

### BRIEF DESCRIPTION OF DRAWING

The accompanying drawing, which is included to provide a further understanding of the invention and is incorporated in and constitutes a part of this application, illustrate embodiment of the invention and together with the description serve to explain the principle of the invention. In the drawing:

FIG. 1 is a diagram showing a method for producing polyurethane synthetic leather using a non-solvent according to a preferred embodiment of the present invention.

### DETAILED DESCRIPTION OF PREFERRED EMBODIMENT

A preferred embodiment according to the present invention will now be explained with reference to the accompanying drawing.

The present invention teaches a technical thought of production of polyurethane synthetic leather, without using a solvent a solvent detrimental to environment and humans, such DMF, MEK, toluene, etc. Specifically, the present invention provides a method for producing non-solvent polyurethane synthetic leather, by using non-solvent polyurethane that is a material created by a secondary reaction between isocyanate and polyol and directly adhering the non-solvent polyurethane to a fabric without carrying out additional drying and adhering processes.

Term “non-solvent polyurethane” means polyurethane free from any solvent detrimental to environment and humans, as described above.

In addition, the present invention utilizes an additional mixing chamber for keeping the polyurethane in a gel state. Preferably, the mixing chamber is a bubbler commercially available from Korean Automation Co. Ltd.

Although the present invention utilizes a fabric itself, a fabric impregnated with water-soluble polyurethane can be used to produce a synthetic leather, if necessary.

### Embodiment

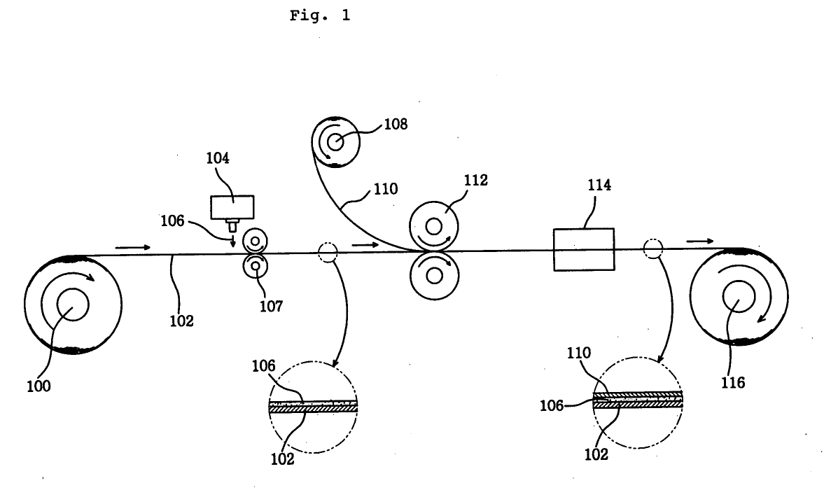

Referring to FIG. 1, a release sheet 102 is wound around a roll 100, and isocyanate and polyol are mixed in a mixing chamber 104, preferably, a bubbler which is commercially available from Korean Automation Co. Ltd. At that time, non-solvent polyurethane 106 is produced by a secondary reaction in the mixing chamber 104. The mixing chamber is maintained at a temperature of 200° C. to 100° C., preferably about 40° C., to reduce a viscosity of the non-solvent polyurethane 106 to be produced.

Then, the release sheet 102 wound around the roll 100 passes between rollers 107, and simultaneously, the non-solvent polyurethane 106 is discharged on a surface of the release sheet 102 in a gel state from the mixing chamber 104.

When the release sheet 102 with the non-solvent polyurethane 106 deposited thereon passes through the rollers 107, a thickness of the non-solvent polyurethane 106 is uniformly maintained. The release sheet 102 passes through rollers 110 together with a fabric 110 wound around a roll 108. When the release sheet 102 and the fabric 110 pass through the rollers 110, they are adhered.

Specifically, while the fabric 110 passes the rollers 112, the fabric is adhered closely to the non-solvent polyurethane 106 of gel state, without using additional adhesive.

Then, the fabric 110 with the non-solvent polyurethane 106 adhered thereto passes through an aging chamber 114 at a temperature of 40° C. during 24 hours, thereby completing the production of the non-solvent polyurethane synthetic leather.

Alternatively, after the non-solvent polyurethane 106 is applied to the release sheet 102 in a uniform thickness, the non-solvent polyurethane 106 may be dried at a temperature of 30 to 100° C. during 10 to 20 seconds.

With the above description, since the present invention does not utilize any harmful solvent, it may prevent the pollution of environment. In particular, since the present invention does not require additional drying and adhering processes, it can reduce a producing process.

The forgoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A method of producing synthetic leather using isocyanate and polyol, the method comprising the steps of:
mixing the isocyanate and the polyol in a mixing chamber to produce non-solvent polyurethane in a gel state;
applying the non-solvent polyurethane onto a release sheet;
adhering a fabric to the non-solvent polyurethane; and
aging the non-solvent polyurethane.

2. The method as claimed in claim 1, further comprising, after the non-solvent polyurethane is applied to the release sheet, drying the non-solvent polyurethane at a temperature of 30 to 100° C. during 10 to 20 seconds.

3. The method of claimed in claim 1, where the aging step is implemented at a temperature of 40° C. during 24 hours.

4. The method of claimed in claim 1, where the fabric is impregnated with water-soluble polyurethane.

5. Polyurethane synthetic leather produced according claim 1.
